(19) United States
(12) Patent Application Publication
(10) Pub. No.: US 2017/0265969 A1
(43) Pub. Date: Sep. 21, 2017

(54) DISPENSING DEVICE FOR A DENTAL MATERIAL AND A METHOD OF FILLING THE DEVICE

(71) Applicant: 3M INNOVATIVE PROPERTIES COMPANY, St. Paul, MN (US)

(72) Inventors: Andreas J. Boehm, Reichling (DE); Marc Peuker, Schondorf (DE); Alexander Walter, Purgen (DE)

(21) Appl. No.: 15/609,632

(22) Filed: May 31, 2017

Related U.S. Application Data
(63) Continuation of application No. 13/516,785, filed on Jun. 18, 2012.

(30) Foreign Application Priority Data
Dec. 22, 2009 (GB) 0922294.4

(51) Int. Cl. A61C 9/00; A61C 5/62; A61C 5/64

(52) U.S. Cl. CPC A61C 9/0026; A61C 5/64; A61C 5/62

(57) ABSTRACT

A dispensing device for a dental material, comprises a container that has a passageway with a front opening for releasing the dental material, and a rear opening. The device has a first fill opening in the passageway arranged between the rear opening and the front opening. The device further has a second fill opening. The device is adapted to receive a piston in the passageway which is movable between the rear opening and the front opening.

### CROSS-REFERENCE TO RELATED APPLICATIONS

This application claims priority to United Kingdom Patent Application No. 0922294.4, filed Dec. 22, 2009.

### FIELD OF THE INVENTION

The invention relates to a dispensing device for a dental material which has a rear opening, a front opening for releasing the dental material, and a fill opening. Further the invention relates to a method of filling such a device.

### BACKGROUND ART

Dental materials are often prepared from two or more components that are mixed together just before use. Often the individual components are obtained as portions from larger packages, for example from tubes, bags or cartridges. There are packages on the market that allow manual or automatic dispensing of two or more components at desired amounts and at an appropriate ratio for mixing. Furthermore there are packages that allow dispensation of portions of readily mixed materials from individually stored components.

An automatic dispensing and mixing system is for example available under the designation 3M™ ESPE™ Pentamix™ from 3M ESPE AG, Germany, and allows automatic dispensing and mixing of two-component dental impression materials. The 3M™ ESPE™ Pentamix™ system is typically used as a tabletop device for filling dental impression trays. However, the 3M™ ESPE™ Pentamix™ system further has an interface which allows a hand-held syringe to be filled with a portion of a readily mixed dental material. A re-usable syringe for use with the 3M™ ESPE™ Pentamix™ system is for example available under the designation Elastomer Syringe from 3M ESPE AG, Germany.

A manual dispensing device is available under the designation 3M™ ESPE™ Garant™ Dispenser from 3M ESPE AG, Germany, and it allows manual dispensing of two-component materials through a static mixer so that a readily mixed material can be obtained. The 3M™ ESPE™ Garant™ Dispenser allows direct application of the mixed material into a patient's mouth because it is provided in the form of a hand-held applicator which carries the dental impression material, and it includes a mixing tip. The mixing tip is dimensioned so that it can be placed even in relatively narrow spaces in a patient's mouth.

Although available dispensing devices may provide for certain advantages there is still a desire for a relatively inexpensive dispensing device which nevertheless provides for a relatively convenient handling. Further such a device is desirably easy to use, and should comply with the hygiene standards required in dentistry.

### SUMMARY OF THE INVENTION

In one aspect the invention relates to a dispensing device for a dental material. The device comprises a container having at least one passageway. The passageway has a front opening for the dental material, and a rear opening. The device has further a first fill opening and a second fill opening. The first fill opening is arranged in the passageway between the rear opening and the front opening. Further the device is adapted to receive a piston in the passageway, and such that the piston is movable between the rear opening and the front opening for extruding the dental material from the device.

The invention is advantageous in that it preferably provides for a dispensing device which can be filled with a portion of a two- or multi-component dental material from a package that holds or that is adapted for holding multiple portions of the dental material. Further the dispensing device may be re-filled after use. Therefore the device of the invention may generally combine advantages of a package for containing material for a single application (single-dose package) with advantages of a package for containing sufficient material for multiple applications (multi-dose package). In particular the dispensing device may allow for receiving components of a dental material in a substantially unmixed form. Further the device may provide for mixing the components. Thus the device of the invention may allow for receiving and mixing individual components from a package that typically is not adapted or intended for providing a mixed material. This may facilitate the work in a dental practice because manual mixing a variety of dental materials may be made unnecessary.

In one embodiment the passageway extends between the rear opening and the front opening. Thus the rear opening and the front opening may be formed by ends of the passageway. The passageway in particular in a section between the first fill opening and the front opening may form a chamber for receiving the dental material. For example the dental material may be received in the passageway in the form of two or more generally unmixed components. The components may for example have a viscosity which allows the components to contact one another, but the majority of a component volume may remain unmixed. The device may further have a mixing element.

For example mixing element may be accommodated in the passageway for mixing the dental material, or the components of the dental material. In this case the front opening of the passageway may also form a dispensing outlet of the device. Further the passageway may merge into a channel for accommodating a mixing element. In this case the channel may provide for a dispensing outlet of the device. The mixing element in this embodiment may be arranged in the channel between the front opening and the dispensing outlet. A mixing element as it generally may be used with the present invention may comprise a series of mixing paddles for dividing and remerging a material flow for mixing the components.

In one embodiment the device forms a passageway having only the rear opening, the front opening and the first fill opening. Alternatively the device may form a passageway having only the rear opening, the front opening and the first and second fill openings.

In a further embodiment the rear opening, the front opening and the first fill opening are in fluid communication with one another. In addition the second fill opening may be in fluid communication with the rear opening, the front opening, and the first fill opening.

In another embodiment the first and second fill openings are arranged at generally the same distance from the front opening. In particular the passageway may extend along a longitudinal axis through the front opening, and the first and second fill opening may be positioned substantially aligned with an imaginary perpendicular line on the longitudinal axis.

In one embodiment the device is adapted for receiving the piston in the passageway between the rear opening and the fill opening such that the piston seals the rear opening from the front opening but the fill opening is in fluid communication with the front opening. The device may be further adapted for positioning the piston between the fill opening and the front opening such that the piston additionally seals the first fill opening from the front opening. This may for example be achieved by a passageway having a generally uniform cross-section over its length, with the first fill opening the passageway laterally. Thus the piston may be moved past the fill opening.

In another embodiment the first and the second fill openings are arranged farther away from the front opening than from the rear opening. Thus the capacity of the passageway between at least the first fill opening and the front opening may be maximized.

Further this embodiment may minimize the distance between at least the first fill opening and the rear opening, and thus the possible travel of a piston received in the passageway.

Therefore when a piston is moved from a position between the rear opening and the fill opening for extruding a dental material only a small portion of the material may be displaced back through the fill opening until the piston has passed the fill opening.

In one embodiment the device is shaped such that the passageway has a generally uniform cross-section over its length. Further the piston may be shaped such that it can seal with walls of the passageway. For example the piston may be of a generally flexible material and oversized with respect to the cross-section of the passageway. The piston may further have radially extending circumferential seal lips or seal bulges. Thus the piston may snugly fit in the passageway and hinder the dental material to pass the piston when pressurized for extrusion.

In one embodiment the second fill opening is arranged in the passageway between the rear opening and the front opening. Therefore in this embodiment the first and the second fill openings both form openings in the same passageway. Therefore the embodiment preferably allows for two components to be filled in the same passageway. For example two components may be simultaneously supplied to fill openings. The two components may thus flow in the passageway side be side.

In another embodiment the device has at least two passageways. Further the first and second fill openings may be arranged in different passageways. Thus one passageway may comprise the first fill opening and the other passageway may comprise the second fill opening. In this embodiment each of the passageways preferably has a rear opening and a front opening. The passageways may further be configured similarly or identical according to other embodiments described herein. In such an embodiment the device may form two passageways which each only have one rear opening, one front opening and one fill opening.

In a further embodiment the device has at least two passageways which merge into a common channel of a dispensing nozzle. The dispensing nozzle may within the channel accommodate a mixing element, as described above.

In one embodiment the device comprises at least two components of the dental material, wherein a majority of the two components are not mixed with one another.

The components may for example contact each other along at least part of the length of the passageway, as described. Further each of the components may be accommodated in a separate passageway. The skilled person will recognize that the device may have more than two passageways that are configured similarly or identically.

In another embodiment the device comprises at least one piston. Further the device may comprise one piston in each passageway. Two or more pistons may be part of or connected with two plungers, or with one common plunger, for example.

In one embodiment the piston provides at least one of the first and second fill openings. For example an embodiment of the device having only one passageway may receive a piston which provides the first and second fill openings. The piston may have the first and second fill openings at or adjacent a front side of the piston. Therefore when the piston is inserted in the passageway with its front side leading the first and second fill openings may be arranged between the rear opening and the front opening.

In another embodiment the device has a first fill adapter which is in fluid communication with the first fill opening. Further the device may have a second fill adapter which in fluid communication with the second fill opening. For example the first and second fill adapters and the first and second fill openings may be connected by first and second fill channels, respectively, formed in the device. The first fill adapter and/or the second fill adapter is/are preferably configured for coupling with a package containing at least one component of the dental material. Such a package may in particular be adapted for containing sufficient dental material for multiple applications. In particular the first fill adapter may be configured for coupling with a first supply orifice of the package for receiving a first component of the dental material. Further the second fill adapter is preferably configured for coupling with a second supply orifice of the package for receiving a second component of the dental material. The first and second fill adapters may further in combination be configured for coupling with a first and second supply orifice, respectively, of the package.

In one embodiment such a first supply orifice of the package forms a first tube end having an outer diameter of about 5.1 mm and an inner diameter of about 1.1 mm, and the second supply orifice of the package forms a second tube end having an outer diameter of about 10.8 mm and an inner diameter of about 9.2 mm. The first and second tube ends are preferably spaced by a center distance of about 18.4 mm from one another.

The diameters of this embodiment correspond to a package which is typically used for providing a dental impression material which can be mixed in a 3M™ ESPE™ Pentamix™ mixing device. Such a package typically is used to fill dental trays and therefore is dimensioned to provide relatively large amounts of material. The device of the invention however preferably can receive a smaller portion from such a package which then may be dispensed relatively precisely in a patient's mouth.

A further aspect of the invention relates to a filling appliance which is adapted for connecting with a dispensing device for a dental material. Preferably such a dispensing device is of a type having a passageway with a front opening for releasing the material, and a rear opening, and being adapted to receive a piston in the rear opening, and adapted such that the piston is movable in the passageway between the rear and the front openings. The filling appliance preferably provides a fill opening and preferably has a fill adapter which is in fluid communication with the fill opening. The fill adapter is preferably configured for coupling with a package containing at least one component of the dental material. Further the filling appliance is adapted to connect with its fill opening to the rear opening of said type of dispensing device.

In one embodiment the filling appliance has at least two fill adapters in fluid communication with at least one fill opening of the filling appliance. In another embodiment the filling appliance at least two fill openings each being in fluid communication with one fill adapter of the filling appliance. One of the fill adapters may be configured for coupling with a first supply orifice of the package for receiving a first component of the dental material, and another one of the fill adapters may be configured for coupling with a second supply orifice of the package for receiving a second component of the dental material. The packages and supply orifices may generally correspond to various embodiments of packages as specified in this specification.

In another embodiment the filling appliance is in combination with a dispensing device for a dental material, wherein the dispensing device has a passageway with a front opening for dispensing the material, and a rear opening, the device being adapted to receive a piston in the rear opening, and adapted such that the piston is movable in the passageway between the rear and the front openings. The filling appliance may be adapted such that it can be mated the passageway with the fill openings positioned between the rear opening and the front opening of the device.

A further aspect of the invention relates to a method of filling a dispensing device for a dental material. The method comprises the steps of:
providing a dispensing device according to the invention as specified herein;
sealing the rear opening by placing a piston in the passageway;
providing a component in the first fill opening; and
providing a further component in the second fill opening.

In one embodiment the method further comprises the step of moving the piston toward the front opening to seal the fill opening from the front opening.

In a further embodiment the method further comprises the step of repositioning the piston from a position between the fill opening and the front opening to a position between the fill opening and the rear opening for sealing the rear opening, providing a component in the first fill opening, and providing a further component in the second fill opening; A further aspect of the invention relates to a method of filling a dispensing device for a dental material. The method comprises the steps of:
providing a dispensing device according to the invention as specified herein, and having two passageways;
sealing each of the rear openings of the two passageways by placing a piston in each passageway;
providing a component in the first fill opening; and
providing a further component in the second fill opening.

In one embodiment the method further comprises the step of moving the pistons toward the front openings of the passageways to seal the first and second fill openings from the respective front openings.

The method of the invention preferably facilitates handling of the dental material delivered from a package.

### BRIEF DESCRIPTION OF THE FIGURES

FIG. 1 is a perspective view of a dispensing device according to an embodiment of the invention;

FIG. 2 is a partial view of the device shown in FIG. 1;

FIG. 3 is a further partial view of the device shown in FIG. 1;

FIG. 4 is a top view of a device according to an embodiment of the invention in combination with a package for containing a dental material;

FIG. 4a is a partial view of the device shown in FIG. 4.

FIG. 5 is a cross-sectional view of a dispensing device according to an embodiment of the invention;

FIG. 6 is a cross-sectional view of a dispensing device according to a further embodiment of the invention;

FIG. 7 is a cross-sectional view of a dispensing device according to still a further embodiment of the invention;

FIG. 8 is a cross-sectional view of a dispensing device according to another embodiment of the invention;

FIG. 9 is a cross-sectional view of a dispensing device according to an alternative embodiment of the invention;

FIG. 10 is a cross-sectional partial view of a dispensing device and a piston according to an embodiment of the invention;

FIG. 11a-11d are cross-sectional partial views illustrating filling steps of the dispensing device shown in FIG. 10;

FIG. 12a-12c are cross-sectional partial views illustrating filling steps of a dispensing device according to an embodiment of the invention;

FIG. 13 is a side view of a dispensing device and a fill appliance according to an embodiment of the invention; and

FIG. 14 is a cross-sectional partial view of the device shown in FIG. 13.

### DETAILED DESCRIPTION OF THE INVENTION

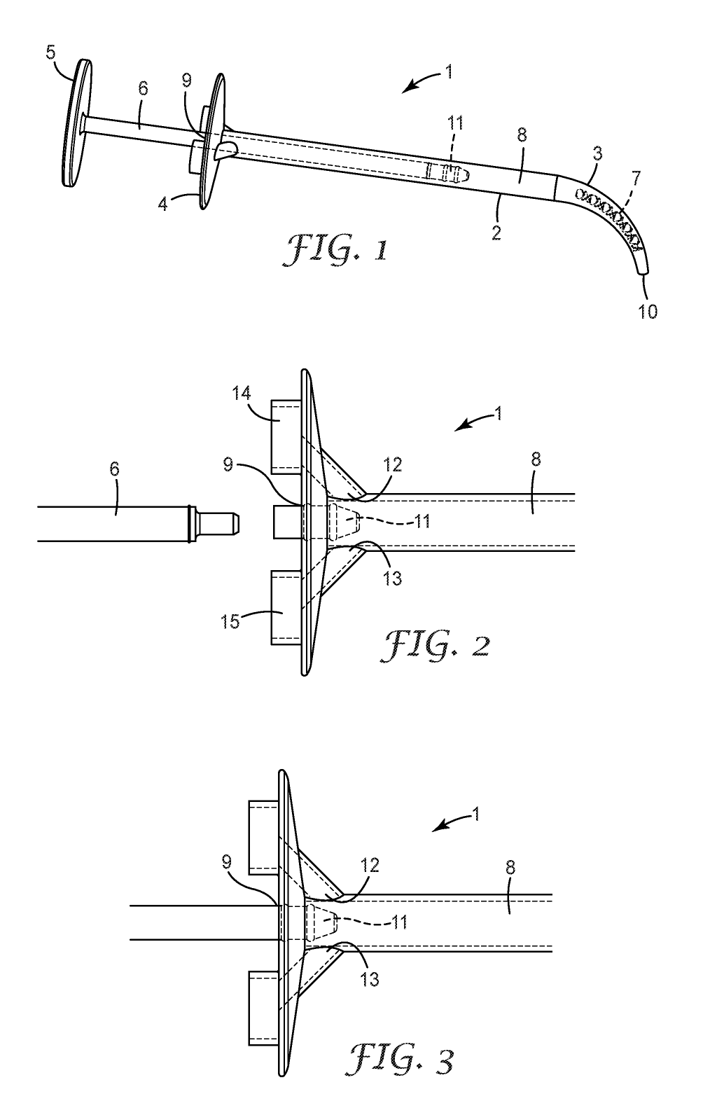

FIG. 1 shows a dispensing device 1 for dispensing a dental material. The device 1 has a container 2 for containing the dental material, and a nozzle 3 from which the dental material can be dispensed. Further the device has a plunger 6 which is movably arranged within the container 2 for extruding the dental material from the device 1. The device 1 has a first pressure plate 4 that is arranged at the container 2 of the device 1, and a second pressure plate 5 that is arranged at the plunger 6.

The first and second pressure plates 4, 5 preferably form finger plates that for example allow a user to manually move the plunger 6 relative to the container 2 for extruding material. In the example the device 1 comprises a static mixer 7 disposed within the nozzle 3. Therefore the device 1 shown preferably allows for the dental material to be provided in the device as separate components that can be mixed in the nozzle 3 as they are dispensed from the device 1. Therefore the device may be used for dispensing a dental material that is readily mixed from separate components. The device 1 has a passageway 8 having a rear opening 9 and a front opening 10. In the example shown the plunger 6 is movably received in the passageway 8 through the rear opening 9. Further the front opening 10 is arranged at a free end of the nozzle 3 and thus also forms a dispensing outlet of the device 1. The plunger 6 has a piston 11 which seals the passageway 8. In the example the piston 11 is a separate component from the plunger 6, but in another example the piston may be formed in one piece with plunger. The skilled person will recognize that in still another example the plunger is optional, for example in a device which is intended for use with a separate applicator device providing a plunger of the applicator for advancing the piston of the device.

FIG. 2 shows a part of the device 1 in more detail. The device 1 has first and second fill openings 12, 13 which are arranged between the rear opening 9 and the front opening (visible in FIG. 1). The piston 11 in the shown position blocks the rear opening 9 of the passageway 8 from fluid communication with the front opening. The piston 11 in this position also blocks the rear opening 9 from fluid communication with the first and second fill openings 12, 13. However the first and second fill openings 12, 13 are in fluid communication with the front opening. Therefore in the illustrated position of the piston 11 the passageway 8 may be filled with a dental material through the first and second fill openings 12, 13. Preferably the first fill opening 12 enables for supplying a first component of the dental material into the passageway 8, and the second fill opening 13 enables for supplying a second component of the dental material into the passageway 8. Thus the passageway 8 may be filled by a first and a second component of a dental material through the first and second fill openings 12, 13, respectively. Thereby the passageway 8 preferably is filled in a direction from the fill openings toward the front opening. Preferably air present in the passageway 8 can escape through the front opening as the passageway 8 fills with material. Further preferably the first and the second components simultaneously fill the passageway 8. Therefore after filling of the device the components preferably are arranged side by side in contiguous strands along the passageway in a direction between the rear opening 9 and the front opening.

The components in the passageway 8 may thus be in contact with one another, but may remain substantially unmixed. Therefore components that are adapted for forming a hardenable material only when mixed may remain substantially soft, although a thin layer in the interface between the components may harden within a hardening time of the material.

Thus if the device 1 is used for dispensing the components within the hardening time adverse effects may substantially not occur. When the hardening time is exceeded an eventually forming thin layer of hardened material may nevertheless substantially not adversely affect dispensing and mixing of the remaining soft components. Such a thin layer of hardened material may be distributed in the mixture during mixing and thus may further substantially not adversely affect the properties of the mixture. The skilled person will recognize that the device may have more than two fill openings for providing more than two components in the passageway.

The device 1 also has a first and a second fill adapter 14, 15. The first fill adapter 14 is in fluid communication with the first fill opening 12, and the second fill adapter is in fluid communication with the second fill opening 13. The first and second fill adapters 14, 15 are preferably configured for coupling with at least one package containing a bulk of at least one component of the dental material. In particular the first and second fill adapters 14, 15 are preferably configured for coupling with first and second supply orifices, respectively. Such supply orifices are preferably connected with the at least one package for supplying first and second components of the dental material.

The fill adapters may generally be shaped to mate with the respective supply orifices, and may have a center distance that generally corresponds to the center distance of the supply orifices. The fill adapters 14, 15 may be configured for coupling with first and second supply orifices that have the following configurations:

D1o=outer diameter of first supply orifice

D1i=inner diameter of first supply orifice

D2o=outer diameter of second supply orifice

D2i=inner diameter of second supply orifice

CD=center distance between first and second supply orifices

P=preferred product or package available on the market

| D1i | D1o | D2i | D2o | CD | |
|---|---|---|---|---|---|
| [mm] | [mm] | [mm] | [mm] | [mm] | P |
| 1.8 | 3.45 | 1.8 | 3.45 | 7.8 | RelyX ™ARC Clicker ™ |
| 1.1 | 5.1 | 9.2 | 10.8 | 18.4 | Pentamix |
| 4.6 | 6.2 | 4.6 | 6.2 | 7.2 | Express ™ 2 Garant 50 ml |
| 4.3 | 6.1 | 4.9 | 6.5 | 7.2 | Impregum ™ Soft Garant 50 ml |
| 3.8 | 5.4 | 5.3 | 7.1 | 7.4 | Protemp ™ 4 Garant 50 ml |
| 3.8 | 5.4 | 5.3 | 7.1 | 7.4 | Xantopen ® |
| 2.6 | 3.8 | 3.8 | 5 | 5.3 | Luxatemp ® smart mix |
| 2.6 | 3.8 | 3.8 | 5 | 5.3 | Tempofit ®N |
| 3.2 | 4.4 | 3.2 | 4.4 | 5.2 | BISICO ® S4 |
| 2.6 | 3.8 | 3.8 | 5 | 5.1 | GC TEMP Advantage ™ |
| 3.2 | 4.4 | 3.2 | 4.4 | 5.1 | I CEM ® |
| 2.6 | 3.8 | 3.8 | 5 | 5.1 | Maxcem Elite ™ |
| 3.2 | 4.4 | 3.2 | 4.4 | 5.1 | G-Cem Automix ™ |
| 2 | 4.8 | 2 | 4.8 | 19.8 | Nimetic ™ Cem |
| 3 | 5.3 | 7 | 10 | 32.3 | Detax Dosimat 10:1 |
| 2.6 | 6.9 | 2.6 | 6.9 | 13 | Kuraray PANAVIA 21 |
| 2.2 | 7 | 2.2 | 7 | 3.6 | TAH Cartridge 1:1 |
| 3 | 4 | 3 | 4 | 9.6 | IVOCLAR Variolink 1:1 |
| 2.2 | 3.5 | 2.2 | 3.5 | 9.2 | GC G-Luting 1:1 |
| 2.6 | 4.3 | 2.6 | 4.3 | 11.1 | Kuraray CLEARFIL`SA 1:1 |
| 3.8 | 5.8 | 8 | 11 | 20.6 | Aquasil Ultra Deca ™ |
| 3.8 | 5.8 | 8 | 11 | 20.6 | Genic ™ Magic Mix |
| 1.6 | 3.3 | 8.6 | 10.4 | 18.4 | Identium ® |

The skilled person will recognize that the fill adapters 14, 15 may form a plug for insertion in the supply orifices or a socket for receiving the supply orifices. Further the fill adapters may have similar dimensions as the supply orifices and a sleeve or tube may be used for connecting a fill adapter with a supply orifice.

The fill adapters in the example each have a fill adapter opening which faces in generally the same direction as the rear opening 9. Thus the fill adapters openings and the rear opening 9 preferably are arranged side by side and facing the same direction. Thereby a relatively compact design may be provided. The Figure further illustrates that the plunger 6 is separable from the piston 11. Thus the plunger 6 may be removable from the piston 11 for coupling the device 1 with a package. Further the plunger 6 may be kept separate from the remainder of the device 1 and may be assembled only shortly before use. This may help minimizing the dimensions of the device, in particular when the piston 11 is placed in a position adjacent the rear opening 9.

FIG. 3 shows the same part of the device 1 as FIG. 2 but with the piston 11 positioned further away from the rear opening 9 and further toward the front opening (not shown). The piston 11 in the position shown blocks the fill openings 12, 13 from fluid communication with the front opening. In this situation the passageway 8 is in fluid communication only with the front opening. Thus a movement of the piston 11 toward the front opening causes material contained in the passageway 8 to be displaced toward the front opening.

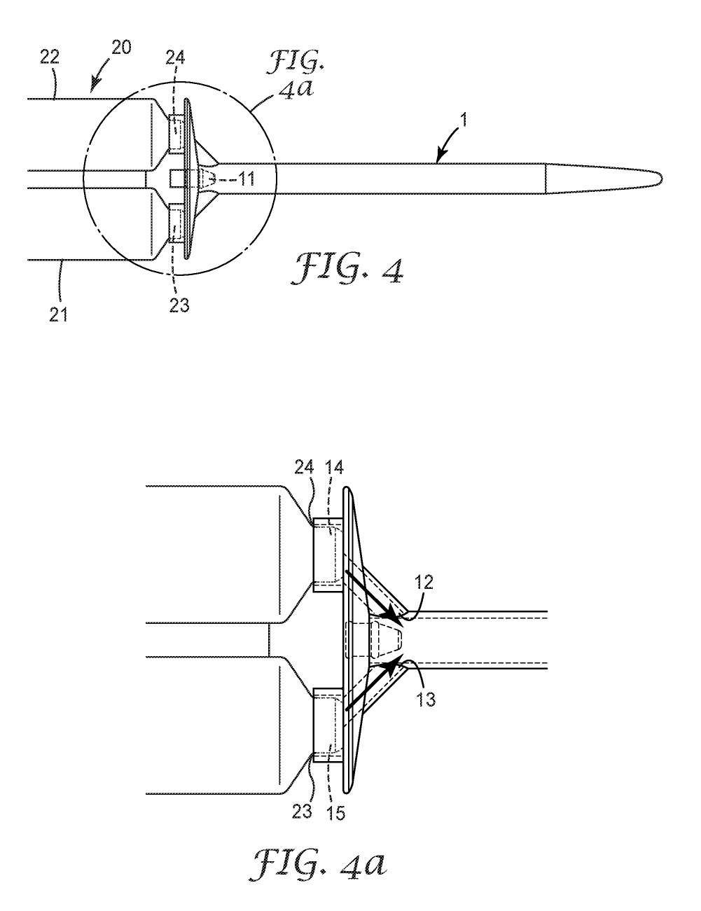

FIG. 4 shows the device 1 coupled with a package 20. The package 20 has first and second chambers 21, 22 for containing first and second components, respectively, of a dental material. Further the package 20 has first and second supply orifices 23, 24 for the first and second chambers 21, 22, respectively. The package 20 may comprise a package piston in each of the chambers 21, 22. The package pistons are preferably movable for extruding the components from the package. The package may be used in combination with an applicator device, for example a manual or automatic applicator device. A manual applicator device is for example available under the designation Garant™ Dispenser from 3M ESPE AG, Germany. An automatic applicator device is for example available under the designation Pentamix™ Mixing Unit from 3M ESPE AG, Germany.

The piston 11 in the device 1 is positioned such that filling of the device 1 is enabled. Therefore the first and second components may be extruded from the package 20 through the first and second supply orifices 23, 24, and thus supplied in the device 1.

This is particularly illustrated in FIG. 4a being an enlarged view of part of the device shown in FIG. 4. The fill adapters 14, 15 are mated with the first and second supply orifices 23, 24. The first and second components can flow through the fill adapters 12, 15 and toward the fill openings 12, 13 as indicated by the arrows. The chambers 21, 22 in the example have generally equal cross-sections so that simultaneous movement of the package pistons causes a generally simultaneous volume flow of the first and the second components in the device 1. Therefore the components may be provided in similar or generally equal amounts (or at a filling ratio of about 1:1) in the device. The skilled person will however recognize that different cross-sections of the chambers of the package may be used for filling the device 1 with components at a different filling ratio. Therefore the same design of the device may be used for a wide range of different desired ratios. The filling ratio preferably also corresponds to the mixing ratio of components that are to be mixed in the device.

FIG. 5 shows a cross-section of a device 30 through a container 31 of the device 30. The device 30 has first and second passageways 32, 33 that are separated by a separation wall 34. The separation wall preferably provides for components received in the passageways 32, 33 to be kept separate. Therefore a chemical interaction between the components received in the device may be prevented. Each of the passageways 32, 33 may therefore have a rear opening (not shown) and a front opening (not shown). The front openings may open in a nozzle or channel which extends between the first and second front openings and a common dispensing outlet.

The device 30 may further have a mixing element 35 which in the example is illustrated at a stage of assembly of the device. The mixing element 35 may be dimensioned such that it can be moved through one of the passageways into the nozzle of the device. Accordingly the nozzle may have a channel for snugly receiving the mixing element. Such a configuration may allow for manufacturing the device including the nozzle first, and subsequently for assembly of the mixing element 35. Thus the device 30 may be usable with or without the mixing element 35, for example as desired by the manufacturer or the user.

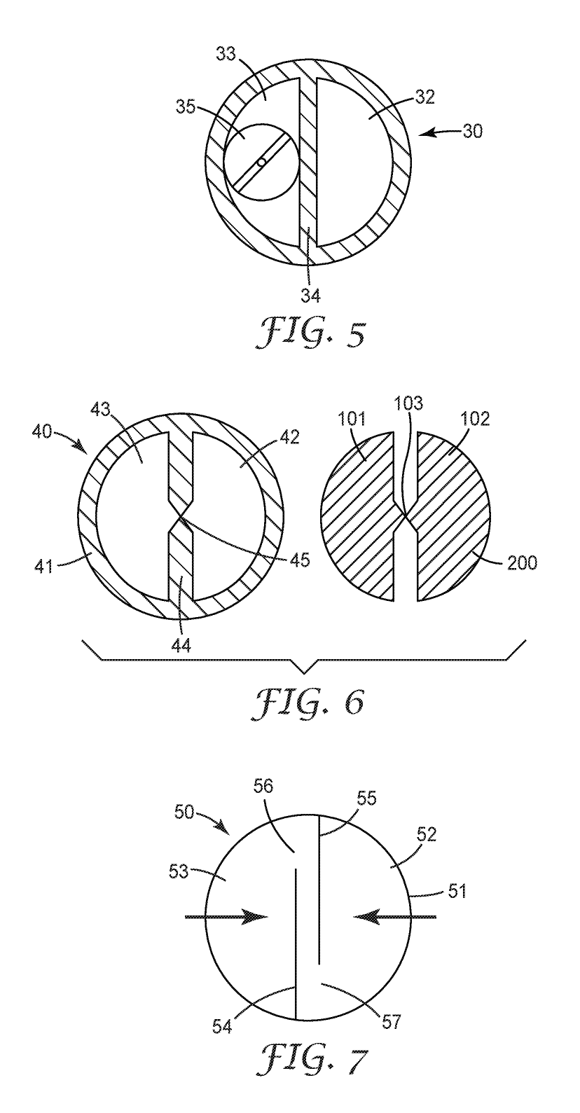

FIG. 6 shows a cross-section of a device 40 through a container 41 of the device 40. The device 40 corresponds generally to the device shown in FIG. 5, and has first and second passageways 42, 43 that are separated by a separation wall 44. However, the separation wall 44 has a gap 45 which connects the first and second passageways 42, 43. The gap 45 may extend along over at least part of the length of the passageways 42, 43 in a direction from a rear opening (not shown) toward a front opening (not shown). FIG. 6 further shows a cross-sectional view of a core 200 as it may be used in an injection molding process for molding the device 40. The core 200 has first and second bars 101, 102 for forming the first and second passageways 42, 43. Further the core 200 has a connecting bar 103 which connects the bars 101, 102. Thus the bars 101, 102 can reinforce each other via the connecting bar 103. Therefore the core may have a relatively high flexural stiffness although it has relatively long bars 101, 102 each having a relatively small cross-section. Such a core may for example allow for molding a device 40 having relatively long passageways 42, 43 which have relatively small cross-sectional shapes. A relatively long and slim device for dispensing a dental material may be advantageous in that it facilitates accessing a narrow space in a patient's mouth. Further such a device due to the slim dimensions may help maximizing a user's view to a location where material is to be dispensed because the device may not block much of the user's view.

A small cross section of the passageway further provides for relatively low extrusion forces. This may for example allow for extruding relatively high viscous materials with the device of the present invention.

The gap 45 is preferably relatively small and dimensioned such that the separation wall keeps components received in the passageways 42, 43 substantially separate. Therefore a chemical interaction between the components may be inhibited.

FIG. 7 shows a cross-section of a device 50 through a container 51 of the device 50. The device 50 corresponds generally to the devices shown in FIG. 5 and FIG. 6, and has first and second passageways 52, 53. The first and second passageways are separated by first and second separation walls 54, 55. However, each of the first and second separation walls 54, 55 leave a gap 56, 57, respectively, through which the first and second passageways 52, 53 are connected. The first and second separation walls 54, 55 in the example are arranged generally parallel relative to each other. The gaps 56, 57 are preferably arranged relative to one another such that each of the walls 54, 55 overlaps the gap of the respective other wall 54 or 55. Further the first and second separation walls 54, 55 are preferably spaced from each other. Therefore the first and second walls 54, 55 may provide for a generally meander shaped passage between the first and second passageways 52, 53 in a direction laterally to the passageways 52, 53. This may also allow for providing an injection molding core which has a connection between bars for forming the passageways. Thus such a core may be provided with a relatively high flexural strength although it may have relatively long and thin bars.

Further the first and/or the second walls 54, 55 may be flexible in a direction laterally to the length of the passageways, for example due to the walls being relatively thin. Thus filling of the first and second passageways 52, 53 may cause the first and second walls 54, 55 to bend towards one another, due to pressure (indicated by the arrows) exerted by the components on the walls during filling. Therefore although the first and second walls 54, 55 may initially leave a passage between the passageways 52, 53 such passage may reduce or close as the device is filled with the components of the dental material.

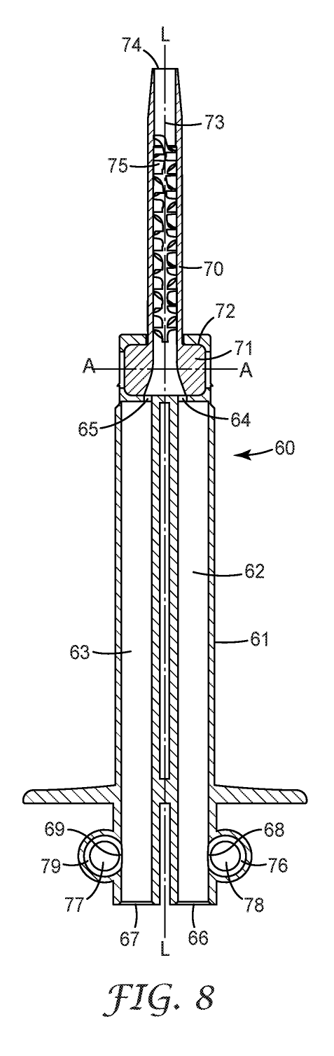

FIG. 8 shows a device 60 having a container 61 extending along a longitudinal axis L and forming first and second passageways 62, 63. The first and second passageways 62, 63 extend generally parallel to the longitudinal axis L.

The first and second passageways 62, 63 further form first and second front openings 64, 65, and first and second rear openings 66, 67, respectively, in the container 61. Further a first fill opening 68 is arranged in the first passageway 62 between the first front opening 64 and the first rear opening 66. A second fill opening 69 is arranged in the second passageway 63 between the second front opening 65 and the second rear opening 67. A piston (not shown) may be disposed in each of the first and the second passageways 62, 63, for example between the rear openings 66, 67 and the fill openings 68, 69. The pistons may be movable within the passageways 62, 63 between the rear openings 66, 67 and the front openings 64, 65.

The device 60 further has a nozzle 70 which is pivotally connected to the device 60. In particular the nozzle 70 has a bearing member 71 which is accommodated pivotally about a rotation axis A within a bearing shell 72 of the container 61. The nozzle 70 has a channel 73 which provides a dispensing outlet 74. In the channel 73 a mixing element 75 is accommodated, for mixing components flowing through the channel 73.

The device 60 is shown in an operative mode in which material contained in the device can be dispensed. In the operative mode the nozzle is positioned such that a fluid communication between the dispensing outlet 74 and the first and second front openings 64, 65 is established via the channel 73. The device further has a storage mode in which components contained in the passageways 62, 63 are hindered from flowing through the front openings 64, 65. In the storage mode the nozzle is positioned such that a surface of the bearing member 71 blocks the front openings 64, 65. This may be achieved by pivoting the nozzle 70 about the rotation axis A by a certain angle, for example by about 30 to at least about 90 degrees.

The device 60 has first and second fill adapters 76, 77 which are in fluid communication with the first and second fill openings 68, 69. The first and second fill adapters 76, 77 form first and second fill adapter openings 78, 79 which face in a direction generally laterally to the longitudinal axis L. Therefore a plunger for moving the pistons or one of the pistons may remain assembled at the device for filling of the device with a dental material.

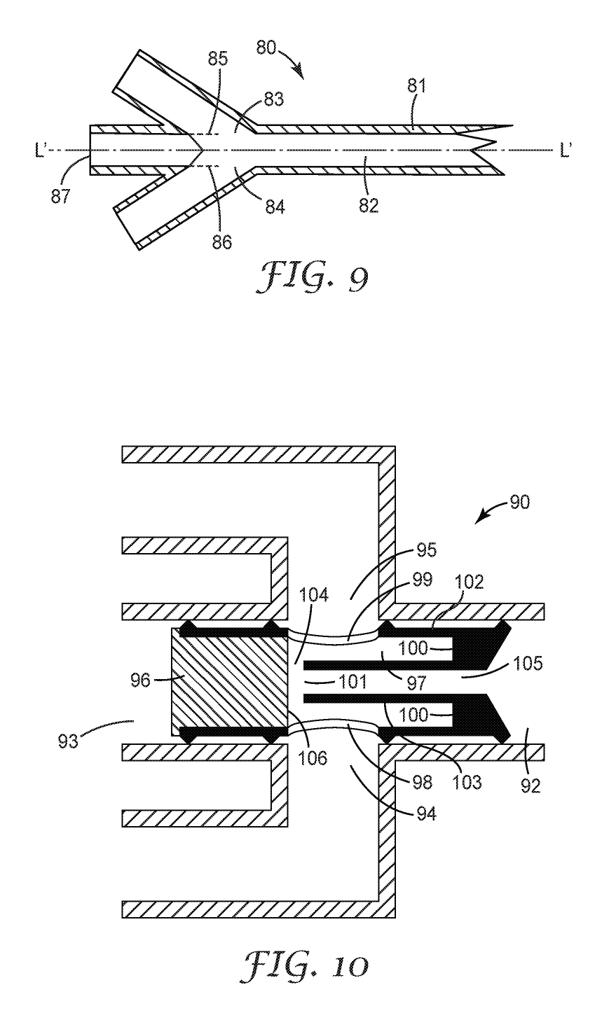

FIG. 9 shows schematically a device 80 having a container 81 that forms a passageway 82 along a longitudinal axis L′. The passageway has a rear opening 87 and a front opening (not shown) opposite of the rear opening 87.

The device 80 has first and second fill openings 83, 84 which open the passageway 82 between the rear opening 87 and the front opening. Further the device 80 has first and second flaps 85, 86. The first and second flaps 85, 86 may be formed as relatively thin flashes that are initially oriented in a direction generally parallel to the longitudinal axis L′. This position is indicated by dashed lines in the Figure. So positioned flaps 85, 86 may be injection moldable in one piece with the container 81 because they may be formed between a core forming the passageway 82 and free ends of cores forming the fill openings 83, 84. Components which are supplied through the first and second fill openings 83, 84 may cause the flaps 85, 86 to bend inwardly in the passageway 82. Thus the flaps 85, 86 may be adapted to reduce or close the cross-section of the passageway 82 between the fill openings and the rear opening (as illustrated). Therefore the components supplied in the passageway may be hindered in flowing in a direction from the fill openings toward the rear opening. The device 80 may therefore not require a piston during filling of the device.

FIG. 10 shows a device 90 having a passageway 92, a rear opening 93, and first and second fill openings 94, 95. A piston 96 is disposed in the passageway 92 of the device 90. The piston 96 forms a reservoir 97. Thereby the piston is adapted to compensate for a non-simultaneous initial flow of components supplied through the fill openings 94, 95. Such a non-simultaneous initial flow of components may occur for example due to the components having different viscosities, or due to different fill levels of the components in a package used for filling, for example, so that one of the components is initially delayed. The piston 96 is configured such that an initial amount of the components is trapped in the reservoir 97 before subsequent components flow into the passageway 92. Therefore components that are initially supplied in the device 90 at a variable or at an undesired flow ratio may be trapped in the reservoir 97. The reservoir may be dimensioned such that a generally uniform and/or desired flow ratio between the components can establish until the reservoir is completely filled. Once the reservoir is completely filled the subsequent components directly (without passing the reservoir) flow into the passageway 92. The reservoir 97 has first and second reservoir inlets 98, 99 which in the position of the piston shown are generally aligned with the first and second fill openings 94, 95 respectively. Further the reservoir has a reservoir outlet 101 which is in fluid communication with the passageway 92. The piston 96 is formed such that the flow resistance for components flowing through the reservoir outlet 101 is higher than the flow resistance for components flowing into the reservoir 97. The piston 96 in the example is formed of two separate parts. Such two parts may allow for relatively easy manufacturing, for example injection molding. The so formed parts may subsequently assembled to form the piston 96.

In the example the reservoir 97 is defined between a generally cylindrical circumferential piston wall 102, first and second inner piston faces 100, 106 and a tube 103. The tube 103 protrudes from the first inner piston face 100 toward the second inner piston face 106, but leaves a (preferably relatively narrow) gap 104 between the free tube end and the second inner piston face 106. The first and second reservoir inlets 98, 99 are arranged in the circumferential piston wall 102 adjacent the second inner piston face 106. The space between the tube 103 and the piston wall 102 preferably is such that the components can flow easier in that space than they can flow through the gap 104. Thus components are enabled to first fill the reservoir 97 before they flow through the reservoir outlet 101.

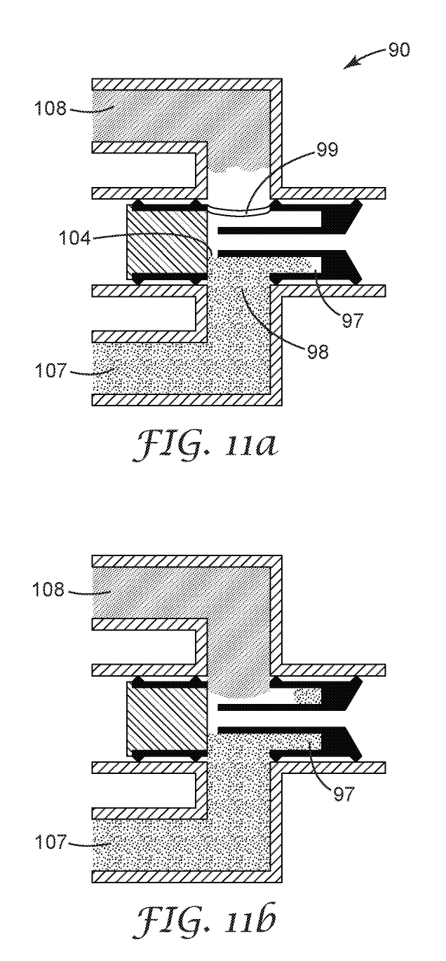

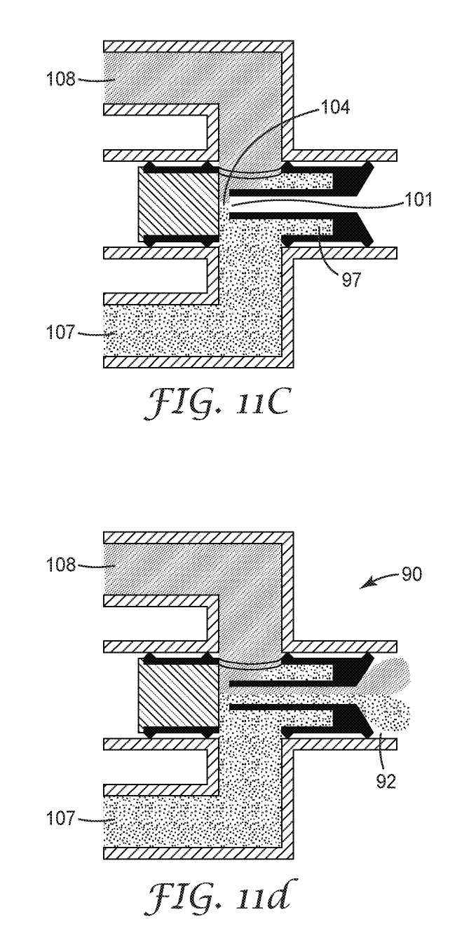

This is explained in greater detail in FIG. 11a through FIG. 11d.

FIG. 11a shows the device 90 in which a first and a second material component 107, 108 are supplied. The flow of the first and second components 107, 108 is non-simultaneous. In particular the flow of the second component 108 is delayed relative to the first component 107. The first component 107 in the situation shown has passed the reservoir inlet 98, is retained at the gap 104, and thus enters the reservoir 97. The second component 108 has not yet reached the reservoir inlet 99.

In the situation shown in FIG. 11b the second component 108 has passed the reservoir inlet 99, and the component 107 has further filled the reservoir 97. A further supply of the first and second components 107, 108 thus causes the reservoir to further fill with both of the first and second components 107, 108.

FIG. 11c shows a situation in which the reservoir 97 has completely or substantially completely filled. A further supply of the first and second components 107, 108 therefore causes the first and second components 107, 108 to pass the gap 104 because the reservoir cannot absorb further material. The components at this stage of supply, preferably being supplied at a defined continuous flow rate ratio, therefore generally simultaneously pass the gap and flow towards the reservoir outlet 101.

FIG. 11d illustrates a situation in which the first and second components 107, 108 have reached the passageway 92 of the device 90. Due to the generally simultaneous flow of the first and second components 107, 108 the passageway 92 is filled with the first and second components 107, 108 at a certain volume ratio relative to one another.

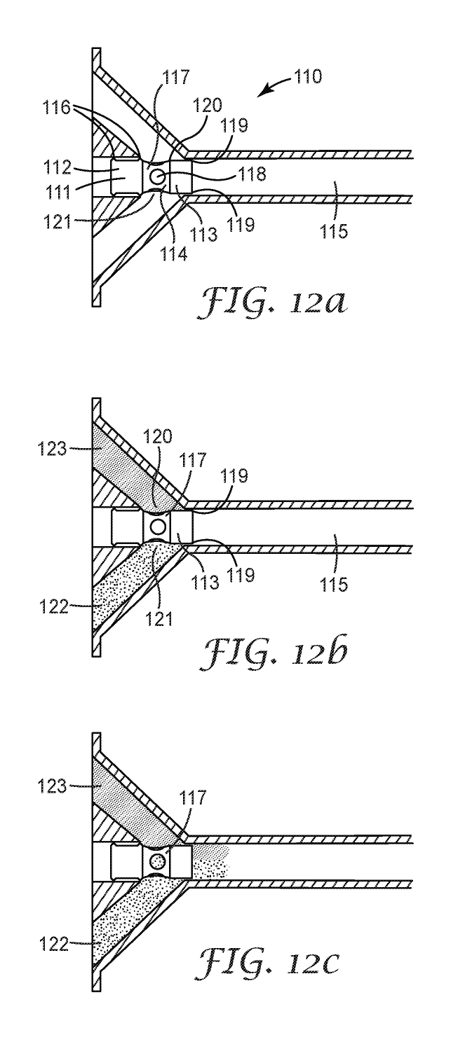

FIG. 12a shows a device 110 according to a further embodiment of the invention. The device 110 and the device 90 shown in FIG. 10 may be similarly or identically configured, but with the device 110 having a different piston than the device 90.

In particular the device 110 has a piston 111 which may be formed in one piece. The piston 111 is generally cylindrical and has a rear portion 112, a front portion 113, and an intermediate portion 114 between the rear and the front portions 112, 113. The rear portion 112 is adapted to seal with walls of a passageway 115 of the device 110. The rear portion 112 therefore has seals 116 which in the example are formed as circumferential lip seals 116. In contrast the front portion 113 is adapted to form a (preferably relatively narrow) gap 119 between the piston 111 and the walls of the passageway 115. The intermediate portion 114 comprises a constriction relative to the cylindrical outer shape of the piston 111. Therefore the constriction forms a reservoir 117 relative to the cylindrical outer shape of the piston 111. The intermediate portion 114 further has recesses 118 providing for an additional volume of the reservoir 117. In the example the recesses form through holes that extend radially through the piston 111 and intersect therein.

In FIG. 12a the piston 111 is positioned with the intermediate portion 114 aligned with first and second fill openings 120, 121 of the device 110, and with the front portion 113 of the piston 111 protruding into the passageway 115 of the device 110. Therefore components supplied through the fill openings 120, 121 can easily flow into the reservoir 117. The front portion 113 of the piston 111 is preferably shaped relative to walls of the passageway 115 such that components supplied through the fill openings 120, 121 are retained in passing the gap 119.

This is illustrated in greater detail in FIG. 12b. In the situation shown a first component 122 and a second component 123 are supplied toward the fill openings 120, 121. The relatively narrow gap 119 between the front portion 113 of the piston 111 and the walls of the passageway 115 hinders the components 122, 123 in passing the gap 119 and flowing toward the passageway 115.

Therefore the components 122, 123 fill the reservoir 117 first, and as the reservoir has filled completely a further supply of the components 122, 123 causes the components to pass the gap 119. As described in the example illustrated in FIGS. 11a-11d the reservoir 117 provides for compensation of an initially non-simultaneous flow of the components, because the pre-flowing initial amount of a component is preferably trapped in the reservoir 117.

This is illustrated in FIG. 12c in which an initial amount of the first component 122 has at least partially filled the reservoir 117, due to a delay of the second component 123. In the situation shown the first and second components 122, 123 are simultaneously supplied in the passageway 115 of the device 110, due to the pre-flowing initial amount of the first component 122 being trapped in the reservoir 117.

FIG. 13 shows a device 130 according to a further embodiment of the invention. The device 130 preferably generally corresponds to the device shown in FIG. 1. Therefore the device 130 has a body 131 which forms a passageway 132. The passageway 132 opens in a rear opening 133 and a front opening 134 that also forms a dispensing opening. The body 131 in this example forms a dispensing nozzle 135 in which a mixing element 136 is accommodated. Further the body 131 may form at least two passageways (not shown). In such an embodiment each of the passageways may have a front opening between the dispensing opening and the rear opening, for example at an area indicated by reference no. 134′. The passageways in such an example may merge in a common channel comprising the dispensing opening and accommodating the mixing element. In contrast to the embodiment shown in FIG. 1 the device 130 has a rim 137 for retaining the device 130 in an applicator device for extruding material from the device 130.

The device 130 comprises a piston 138 which provides the device 130 with first and second fill openings 139, 140 at a front of the piston 138. The piston 138 is received at least with its front within the passageway 132 of the device 130. Thus the fill openings 139, 140 are arranged between the rear opening 133 and the front opening 134 of the passageway 132. The piston 138 further provides first and second fill adapters 141, 142. The first fill adapter 141 is in fluid communication with the first fill opening 139, and the second fill adapter 142 is in fluid communication with the second fill opening 140. In the example a filling appliance 150 is provided which comprises a first interface for coupling with the first and second fill adapters 141, 142 of the piston 138, and a second interface for coupling with a package containing at least one component of the dental material. Thus the filling appliance 150 allows for coupling the device 130 with a package containing at least one component of the dental material.

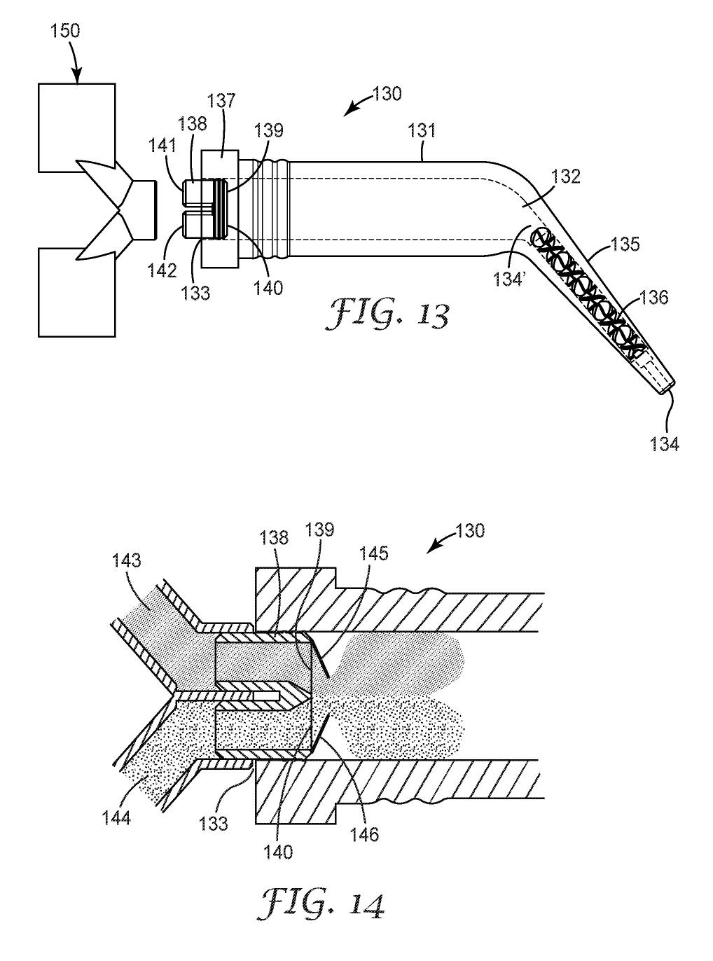

The piston 138 of the device 130 is shown in more detail in FIG. 14. The piston 138 in the situation shown is coupled via the filling appliance 150 to a package from which a first and a second component 143, 144 of a dental material are supplied in the device 130. The piston 138 has first and second flaps 145, 146 that are adapted to close the first and second fill openings 139, 140, respectively. However in the situation shown the flaps 145, 146 are positioned in an open position away from the fill openings 139, 140. The flaps 145, 146 may for example be urged toward the open position from pressure of the components supplied toward the fill openings. Further when the piston is moved in a direction from the rear opening 133 toward the front opening (shown in FIG. 13) for extruding the components, the flaps may be urged toward a closed position due to extrusion pressure exerted on the flaps. Thus the piston 138 may be generally adapted for automatically opening the fill openings when the device is filled with a material, and may further be adapted for automatically closing the fill openings when used for extruding material from the device 130.

1. A system having a dispensing device for a dental material and a package, wherein the package contains a first component and a second component of the dental material, and the package has a first supply orifice and a second supply orifice, the device comprising:
a container having at least one passageway which has a front opening for releasing the dental material and has a rear opening;
a first fill opening being arranged in the passageway between the rear opening and the front opening;
a second fill opening being arranged in the passageway between the rear opening and the front opening;
a first fill adapter which is in fluid communication with the first fill opening and a second fill adapter which in fluid communication with the second fill opening; and
a static mixer in the container,
wherein the device is adapted to receive a piston in the passageway such that the piston is movable between the rear opening and the front opening for extruding the dental material from the device,
wherein the first fill adapter is configured for coupling with the first supply orifice of the package for receiving the first component of the dental material, and the second fill adapter is configured for coupling with the second supply orifice of the package for receiving the second component of the dental material,
wherein the first and second fill adapters form a plug for insertion in the first and second supply orifices or a socket for receiving the first and second supply orifices.

2. The system of claim 1, wherein the first and second fill openings are arranged farther away from the front opening than from the rear opening.

3. The system of claim 2, wherein the first and second fill openings are arranged at the same distance from the front opening.

4. The system of claim 1, comprising two components of the dental material, wherein a majority of the two components are not mixed with one another.

5. The system of claim 1, wherein which the first supply orifice of the package forms a first tube end having an outer diameter of about 5.1 mm and an inner diameter of about 1.1 mm, and the second supply orifice of the package forms a second tube end having an outer diameter of about 10.8 mm and an inner diameter of about 9.2 mm.

6. The system of claim 1, wherein the container includes first and second passageways separated by a separation wall.

7. The system of claim 6, wherein the static mixer is dimensioned such that the mixer can be moved through one of the first and second passageways.

8. The system of claim 6, wherein the separation wall has a gap connecting the first and second passageways.

9. The system of claim 8, wherein the gap is dimensioned such that the separation wall keeps components in the first and second passageways substantially separate.

10. The system of claim 1, wherein the container includes first and second passageways separated by first and second separation walls with a gap between the first and second separation walls, wherein the gap connects the first and second passageways.
